(19) United States
(12) Patent Application Publication
(10) Pub. No.: US 2012/0319466 A1
(43) Pub. Date: Dec. 20, 2012

(54) Method for activating a switching valve in a hydraulic motor vehicle brake system

(76) Inventors: Michael Bunk, Leingarten (DE); Matthias Schanzenbach, Eberstadt (DE); Michael Reichert, Tamm (DE); Markus Jung, Untergruppenbach (DE)

(21) Appl. No.: 13/512,097

(22) PCT Filed: Oct. 4, 2010
(86) PCT No.: PCT/EP2010/064748

§ 371 Date: Aug. 31, 2012

(30) Foreign Application Priority Data
Dec. 1, 2009 (DE) 10 2009 047 335.1

(51) Int. Cl. B60T 7/12; B60T 13/16

(52) U.S. Cl. 303/11

(57) ABSTRACT

In a method for carrying out an automatic braking in a motor vehicle with the aid of a pump which delivers a brake fluid in the direction of the wheel brakes, the brake pressure prevailing in the brake circuit is limited by a valve, which is overflowed when a settable pressure threshold is reached, and thus limiting the brake pressure. The dynamics of the pressure build-up is improved if the valve opens only at higher pressures, since a greater share of the volume flow coming from the hydraulic pump is then in fact conducted to the wheel brakes and is not able to flow off prematurely via the valve.

### BACKGROUND OF THE INVENTION

1. Field Of The Invention

The present invention relates to a method for activating a valve.

2. Description Of The Related Art

Modern brake systems, which are designed for a vehicle dynamics control system, normally have a plurality of valves, with the aid of which it is possible to control the build-up or reduction of pressure in the wheel brakes depending on situations.

FIG. 1 shows the essential part for the present invention of a hydraulic brake system known from the related art which is designed for implementing a vehicle dynamics control system. The part of the brake system shown includes a brake master cylinder 1 having a fluid reservoir, a switching valve (USV) 2, which is normally open, an on-off valve (HSV) 3, which is normally closed, a hydraulic pump (RFP) 4, an intake valve (EV) 5, and a wheel brake (RB) 6 situated in the wheel. A brake line exiting brake master cylinder 1 branches to USV 2 and to HSV 3. The hydraulic pump is situated downstream from

HSV 3 and is able to deliver brake fluid to wheel brakes 6 via intake valve 5 when HSV 3 is open. Area A denotes a graduated circle between USV 2, hydraulic pump 4 and EV 5.

In the stable driving condition of the vehicle (normal condition), hydraulic pump 4 is not active. USV 2 is open and HSV 3 is closed. Operating a foot brake pedal (not shown) causes brake pressure from brake master cylinder 1 to be built up on wheel brake 6 via USV 2 and EV 5.

In a critical driving situation, a regulator 8 intervenes in the vehicle operation. In this case, hydraulic pump 4 is activated by control unit 7, USV 2 is closed and HSV 3 is opened. Hydraulic pump 4 then pumps hydraulic fluid from the reservoir into wheel brake 6 via intake valve 5 and automatically builds up brake pressure. To this end, regulator 8 predefines a setpoint pressure curve.

According to the current related art, two different methods are used for regulating the pressure in the wheel brakes and they will be explained briefly below:

In the case of the first method (suction regulation), HSV 3 is opened during the entire pressure build-up and USV 2 is closed. FIG. 2 shows the main curve of volume flows q_{Rfp}, q_{USV}, q_{EV} on hydraulic pump 4 and on valves USV 2 and EV 3, as well as the curve of the pressure n r wheel in the wheel brake.

When hydraulic pump 4 is switched on, valve 3 is opened and valve 2 is closed simultaneously at point in time t₂₁, the entire volume flow generated by pump 4 is directed to wheel brakes 6 via valve 5. As soon as a target pressure n r target is reached, HSV 3 is closed at point in time t₂₂. Hydraulic pump 4 continues to run; however, it can no longer suction fluid, so that volume flow q_{Rfp} on hydraulic pump 4 and volume flow q_{EV} on the intake valve become zero. USV 2 is completely closed during the entire time. Volume flow q_{USV} on USV 2 is thus zero.

This method has the advantage that the entire brake fluid volume delivered by pump 4 flows into the wheel brake and thus a maximum dynamics of the pressure build-up in the brake is reached. However, a disadvantage is that target pressure p_{target} is exclusively determined at the point in time in which HSV 3 is activated and closed. These points in time are as a rule empirical values which are ascertained empirically. However, in the real brake system, the output of the pump and in particular the elasticity of the wheel brake are subject to considerable fluctuation during their life. This same output duration of hydraulic pump 4 will therefore result in different target pressures n r target as a function of the condition of the brake system.

The shape of the curve over time of the pressure build-up in the wheel brake may be approximately represented by

$$\frac{d p}{d t} = \frac{1}{{E}_{B}} \frac{{U}_{Rfp}}{2 π k} {V}_{Rfp} = \frac{1}{{E}_{B}} η {V}_{Rfp} ,$$

where E_{B}, denotes the elasticity of the wheel brake and k is a pump parameter which represents the relationship between a pump voltage U_{Rfp} and pump speed n =U_{Rfp}/2πk. The value of elasticity E_{B}, is subject to manufacturing and aging related influences and may therefore vary a great deal; this has a significant influence on the pressure build-up. The variations of motor constant k also influence the quality of the pressure build-up. V_{Rfp} is the volume delivered by the pump during one rotation. Since the chronological duration T of the pressure build-up is predefined by the duration of the opening of HSV 3, the actually reached maximal pressure p_{Max} in the wheel brake

$${p}_{Max} = {\int }_{o}^{T} \frac{1}{{E}_{B}} \frac{{U}_{Rfp}}{2 π k} {V}_{Rfp} d t$$

is to a great degree a function of the variables. The possible deviation from intended target pressure p_{target} is thus also considerable.

In the second known method, USV 2 is used for precisely adjusting target pressure p_{target}. FIG. 3 shows the schematic curve of volume flows q_{Rfp}, q_{USV}, q_{EV} on hydraulic pump 4 and valves USV 2, EV 3, as well as pressure curve p_{wheel} in the wheel brake. At point in time t₃₁, HSV 3 is opened and hydraulic pump 4 is switched on. A linear pressure build-up ensues in this case also, the curve of which is determined substantially by pump speed n. Current intensity I on USV 2 is adjusted in such a way that valve 2 is overflowed as soon as a differential pressure Δp which is equal to required target pressure p_{target} is present on it. This target pressure is reached at point in time t₃₂, so that USV 3 opens. Volume flow q_{EV} on EV 5 then becomes zero.

USV 2 may be used for precisely setting a required target pressure. However, in the present case, the precision of the pressure setting is obtained in exchange for a loss in dynamics. This disadvantage is attributable to the fact that volume flow q_{Rfp} coming from pump 4 is not uniform but is instead pulsed as shown in FIG. 4.

The hydraulic pump is as a rule a pump having a non-uniform delivery characteristic, for example, a single-piston pump. When such a pump is operated, suction phases C and delivery phases B are alternated periodically. The volume flow delivered by the pump during a complete rotation fluctuates between zero and a maximum. As a result, the periodically occurring back-pressure of the brake fluid on EV 5 causes a likewise periodically fluctuating stagnation pressure p_{A} to occur in partial circuit A (FIG. 1). If the pressure in partial circuit A is higher than pressure threshold value (P_{target}) set on USV 2, USV 2 is overflowed so that a portion of the brake fluid flows off via the USV. This portion is thus no longer available for the pressure build-up and the pressure build-up on wheel brake 6 is slowed accordingly.

FIG. 5 shows the shape of the curve over time of a typical pressure build-up in wheel brake 6. The setpoint pressure predefined by regulator 8 is identified as pₛₑₜₚₒᵢₙₜ. In the figure, the setpoint pressure increases linearly until a target pressure p_{target} is reached. The pressure acting on wheel brake 5 is identified as p_{wheel}. As may be seen, pressure p_{wheel} rises more slowly due to the loss of volume via USV 2 and may possibly not reach the required target pressure. The latter may also be the case if, as shown in FIG. 5, the braking operation is very short and the pressure in wheel brakes 6 is reduced again early.

### BRIEF SUMMARY OF THE INVENTION

Therefore, an object of the present invention is to combine the advantages of both methods and thus achieve both a high dynamics of the pressure build-up as well as a high precision in setting the target pressure.

According to the present invention, it is proposed to set the pressure threshold value on one valve, in particular the USV, higher during the pressure build-up phase than a setpoint pressure predefined by the regulator. This has the advantage that the valve only opens at a higher pressure and thus the dynamics of the pressure build-up is not slowed as severely. Thus, a larger portion of the volume flow delivered by the hydraulic pump is actually directed to the wheel brakes and it does not flow off prematurely via the valve.

According to a preferred specific embodiment of the present invention, it is proposed to set the pressure threshold value on the valve lower than the pressure peaks produced by the pump. In this way, at least a portion of the brake fluid flows off via the valve in the direction of the brake master cylinder or a fluid reservoir. This has the advantage that the regulator may set the speed of the pump higher than the minimum required for the pressure build-up.

The pressure threshold value is preferably set in such a way that the brake pressure acting on the wheel brake corresponds to the desired setpoint pressure in the shape of the curve over time. In this case, the braking effect of the wheel brake displays exactly the curve requested by the regulator.

The pressure threshold value is preferably reascertained regularly during the pressure build-up phase. As soon as a desired maximum target pressure is reached, the pressure threshold value is set to this value. This ensures that the pressure in the wheel brakes is held at this value.

The pressure threshold value may be, for example, calculated based on a model or read out from a set of characteristics. According to a preferred specific embodiment of the present invention, it is proposed to calculate the pressure threshold value as a function of a mean volume flow. The mean volume flow is the volume flow which must flow in the direction of the wheel brake so that that the brake pressure prevailing in it essentially corresponds to the desired setpoint pressure curve. The pressure threshold value to be set on the valve is in this case a function of the mean volume flow and, if necessary, additional variables which describe the characteristics of the brake, for example, the throttle properties of the intake valve of the wheel brake.

Alternatively, it is proposed to read out the pressure increase from a set of characteristics. This method may be used if the required parameters are not known or not known with sufficient precision.

The proposed set of characteristics may represent, for example, the pressure threshold value as a function of a mean volume flow in the direction of the wheel brake or a gradient of the setpoint pressure.

### BRIEF DESCRIPTION OF THE DRAWINGS

FIG. 1 shows a part of a hydraulic brake system known from the related art which is designed for a vehicle dynamics control system.

FIG. 2 shows the curve of the volume flows on different valves, and the pressure on the wheel brake for the method of suction regulation.

FIG. 3 shows the curve of the volume flows on different valves, and the pressure on the wheel brake in the case of a regulation method in which the USV acts as a pressure-relief valve.

FIG. 4 shows the curve of the volume flows on different valves, and the pressure on the wheel brake with consideration for the delivery characteristic of a single-piston pump.

FIG. 5 shows the shape of the curve over time of a pressure build-up on the wheel brake in the case of a regulation method in which the USV acts as a pressure-relief valve.

FIG. 6 shows the volume flows and the pressure threshold values derived from them according to a specific embodiment of the present invention.

FIG. 7 shows the pressure curve in a wheel brake with and without an increase of the pressure threshold value according to the present invention.

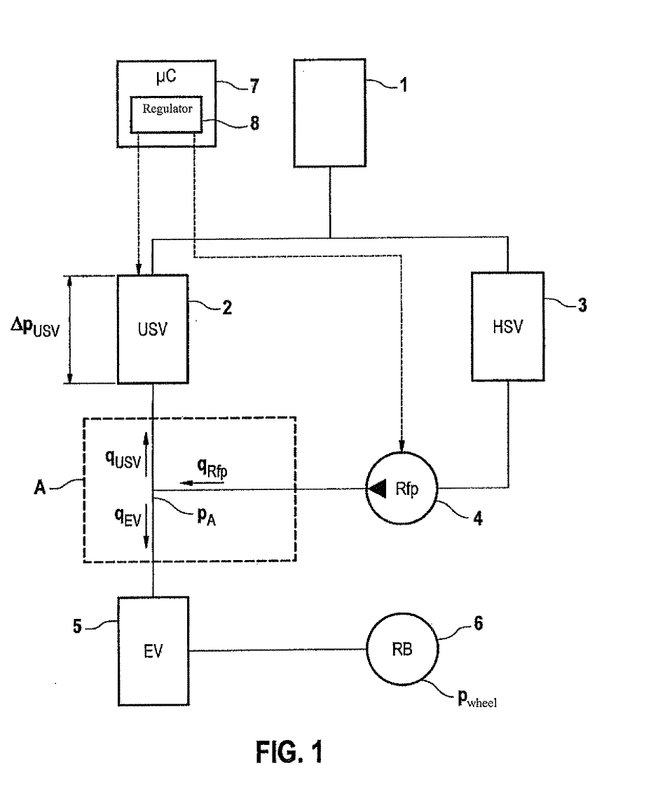

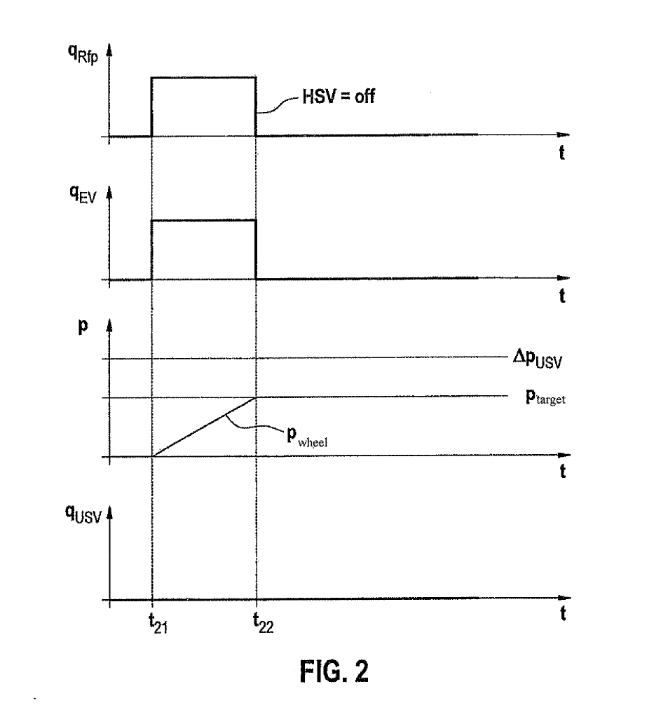

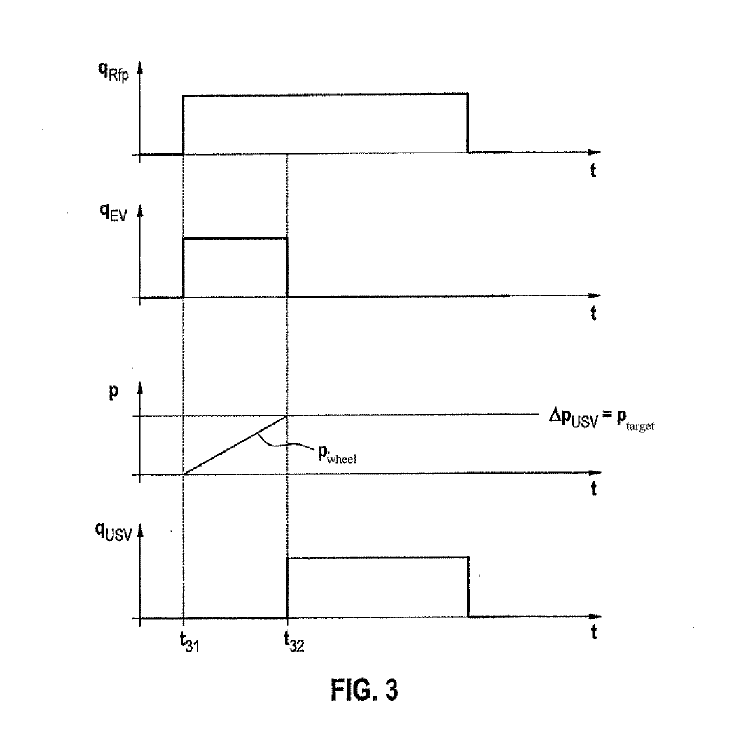

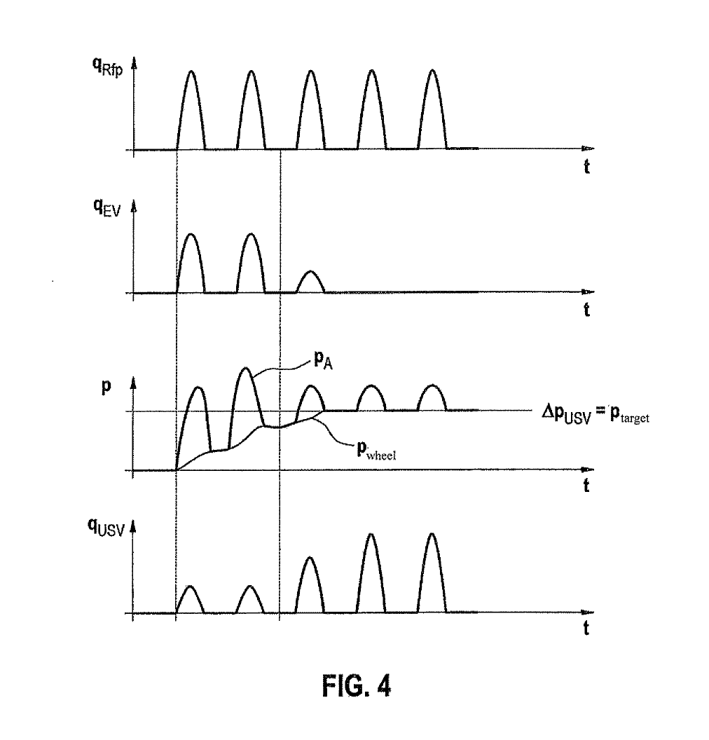

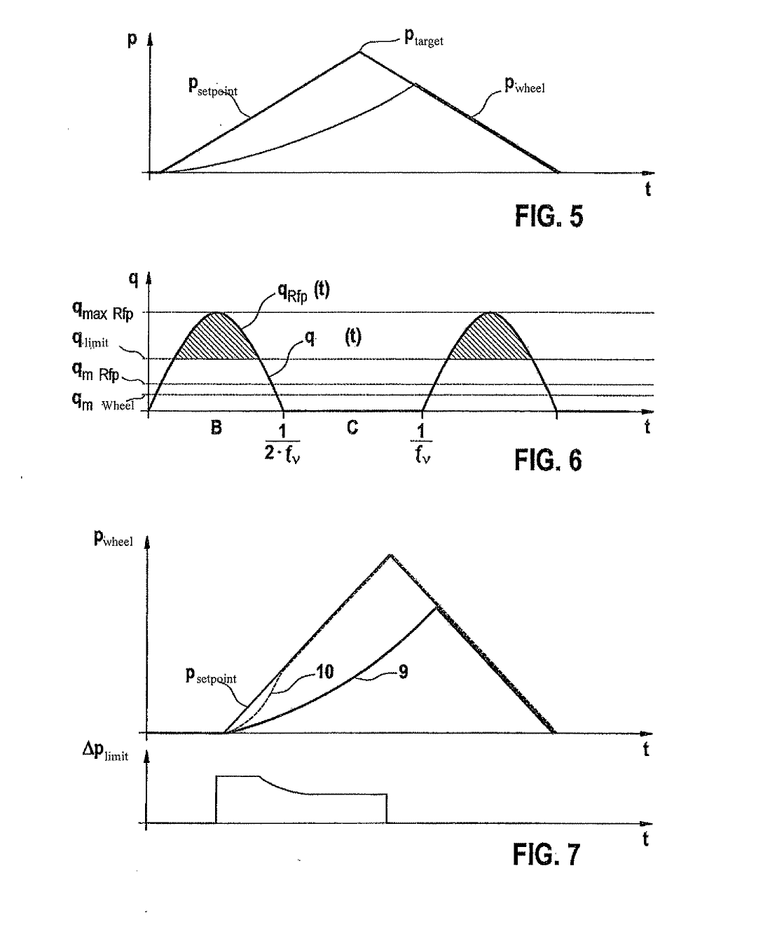

### DETAILED DESCRIPTION OF THE INVENTION

FIG. 6 shows a schematic curve of volume flows q_{Rfp}(t) on hydraulic pump 4, which are changeable over time, and q_{wheel} (t) through intake valve 5 to wheel brakes 6.

During delivery phase B of the pump, q_{Rfp}(t) runs in the form of a half sine wave having a frequency f₀ corresponding to the rotational speed. During suction phase C, q_{Rfp}(t) is equal to zero. From the properties of the pump and the present rotational speed, it is possible to ascertain the mean volume flow of the hydraulic pump qₘ_{_{—}}_{Rfp} in control unit 7. The maximum qₘₐₓ_{_{—}}_{Rfp} of the volume flow on pump 4 may be determined from using qₘₐₓ_{_{—}}_{Rfp}=π·qₘ_{_{—}}_{Rfp}. In this way, the amplitude of the curve is also known.

In order to build up the pressure in wheel brakes 6 using the dynamics requested by regulator 8, a specific mean volume flow qₘ_{_{—}}_{wheel} must flow into wheel brakes 6 via intake valve 5. Since a portion of the fluid flows away via USV 2 in the direction of brake master cylinder 1 in each delivery phase B of hydraulic pump 4, qₘ_{_{—}}_{wheel} is lower than mean volume flow qₘ_{_{—}}_{Rfp} produced by pump 4. The portion of the fluid flowing off is represented by a shaded area in FIG. 6. The remaining portion (under qₗᵢₘᵢₜ) flows into wheel brake 6.

The mean volume flow to the wheel brakes is obtained from the relationship

$${q}_{m \_ wheel} = {f}_{0} {\int }_{0}^{1 / {f}_{0}} min ( {q}_{limit} , {q}_{Rfp} ( t ) ) d t .$$

From this, it is possible to ascertain threshold value qₗᵢₘᵢₜ which is a function of qₘ_{_{—}}_{wheel} and qₘ_{_{—}}_{Rfp}, both of which are known.

From the valve properties, throttle characteristic α and throttle diameter d and density ρ of the brake fluid, it is possible to obtain the pressure threshold value Δpₗᵢₘᵢₜ to be set on USV 2 using C=(απd²/4) \sqrt{2/ρ}.

$$Δ {p}_{limit} = \frac{{q}_{limit}^{2}}{{C}^{2}} .$$

This pressure threshold value in turn corresponds to a determined current intensity I on USV 2. If this current intensity is set, the pressure build-up on the wheel brake essentially follows the setpoint. The remaining fluid, which is represented by a shaded area in FIG. 6, flows away via USV 2.

During the pressure build-up phase, mean volume flow pₘ_{_{—}}_{wheel} to the wheel brake, which is required for the increase of the brake pressure by a determined value, is reduced. This is accompanied by a corresponding shift of threshold value qₗᵢₘᵢₜ and of pressure threshold value Δpₗᵢₘᵢₜ to lower values. The latter is therefore redetermined in regular intervals, for example, every 5 ms, and USV 2 is activated accordingly.

FIG. 7 shows a typical curve of setpoint pressure pₛₑₜₚₒᵢₙₜ output by regulator 8 and the actual pressure on the wheel brake with and without the pressure correction according to the present invention (characteristic curves 10 and 9). The associated curve of pressure threshold value Δpₗᵢₘᵢₜ is included in the representation.

FIG. 7 shows clearly that it is possible to well adjust actual pressure p_{wheel} in the wheel brakes to setpoint pressure pₛₑₜₚₒᵢₙₜ with the aid of the method.

1-10. (canceled)

11. A method for carrying out an automatic braking in a motor vehicle, comprising:
building up brake pressure in a brake circuit during a pressure-build-up phase with the aid of a pump;
setting a pressure threshold value for the valve during the pressure-build-up phase, wherein the pressure threshold is higher than a predefined setpoint brake pressure; and
limiting the brake pressure prevailing in the brake circuit using a valve which is overflowed when the pressure threshold is reached.

12. The method as recited in claim 11, wherein the pressure threshold value set during the pressure-build-up phase is lower than pressure peaks produced by the pump, so that at least a portion of a fluid delivered by the pump escapes via the valve.

13. The method as recited in claim 12, wherein the pressure threshold value is set in such a way that a shape of a time curve of the brake pressure in the brake circuit essentially corresponds to a predefined setpoint curve.

14. The method as recited in claim 12, wherein the pressure threshold value is periodically reset during the pressure-build-up phase.

15. The method as recited in claim 12, wherein the pressure threshold value is set to the value of a desired target pressure when the desired target pressure is reached.

16. The method as recited in claim 12, wherein a required pressure increase is ascertained by determining the amount by which the pressure threshold value exceeds the setpoint brake pressure.

17. The method as recited in claim 12, wherein the pressure threshold value is calculated as a function of a mean volume flow required to be delivered in the direction of wheel brakes so that the brake pressure prevailing in the brake circuit essentially corresponds to the setpoint brake pressure.

18. The method as recited in claim 16, wherein the required pressure increase correlated to a set of brake circuit characteristics.

19. The method as recited in claim 18, wherein the set of brake circuit characteristics represents a pressure increase as a function of a mean volume flow required to be delivered in the direction of wheel brakes so that the brake pressure prevailing in the brake circuit essentially corresponds to the setpoint brake pressure.

20. A control unit for carrying out an automatic braking in a motor vehicle, comprising:
means for building up brake pressure in a brake circuit during a pressure-build-up phase with the aid of a pump;
means for setting a pressure threshold value for the valve during the pressure-build-up phase, wherein the pressure threshold is higher than a predefined setpoint brake pressure; and
means for limiting the brake pressure prevailing in the brake circuit using a valve which is overflowed when the pressure threshold is reached.
